(19) United States
(12) Patent Application Publication
(10) Pub. No.: US 2010/0194053 A1
(43) Pub. Date: Aug. 5, 2010

(54) GASKET AND PACKING PANEL ASSEMBLY FOR TRUNNION/SHAFT

(76) Inventors: Jacques GOURDE, Ascot Corner (CA); David MARCHAND, Ste-Catherine-de-Hatley (CA); Jocelyn GAGNON, Sherbrooke (CA)

Correspondence Address: OGILVY RENAULT LLP, 1, Place Ville Marie, SUITE 2500, MONTREAL, QC, H3B 1R1, CA

(21) Appl. No.: 12/698,343

(22) Filed: Feb. 2, 2010

Related U.S. Application Data
(60) Provisional application No. 61/149,145, filed on Feb. 2, 2009.

(51) Int. Cl. F16J 15/18

(52) U.S. Cl. 277/510

(57) ABSTRACT

A gasket and packing panel assembly comprises a packing panel that forms a stuffing box about a trunnion/shaft. A backing ring about the trunnion/shaft is connected to the packing panel and moves in an axial direction relative to the trunnion/shaft, reducing an axial dimension of the stuffing box. A gasket is located in the stuffing box. The gasket comprises a resilient body from which at least one lip seal projects towards the trunnion/shaft. The lip seal contacts the trunnion/shaft when the backing ring applies a pressure on the gasket. A gasket for use as a seal inside the stuffing box is also provided.

### CROSS-REFERENCE TO RELATED APPLICATION

The present application claims priority on U.S. Provisional Patent Application No. 61/149,145, filed on Feb. 2, 2009, and incorporated herein by reference.

### FIELD OF THE APPLICATION

The present application relates to sealing elements and, more particularly, to a gasket used in a stuffing box to seal a trunnion or shaft.

### BACKGROUND OF THE ART

In some instances, shafts or trunnions have a diameter too big for being supported by bearings. In some cases, a liner journals the shafts or trunnions. In some applications, it is desired to protect the liner or supporting member from liquids handle in a tank or reservoir in which the shaft projects. For example, vats are commonly used in the pulp and paper industry to separate liquids from solids. A washer drum is journaled in the vat, and is rotated to separate the liquids from solids from pulp or stock. In one type of washer drums, the washer drum is supported at an axle end by a bearing and at a trunnion end by a liner, other alternatives are possible. The trunnion has a large diameter, which prevents it from being supported by a bearing.

As illustrated in FIG. 1 of the prior art, a trunnion or shaft is illustrated at 1. The trunnion 1 passes through an opening in a tank, reservoir, vat or the like, to reach the liner (not shown) or supporting member. A packing panel 1 seals off the trunnion opening in the vat, to prevent liquid (e.g., pulp/stock) from exiting the tank. The packing panel 2 has a circular opening in which the trunnion 1 is passed. Because of the absence of a bearing between the trunnion 1 and tank or vat, there is clearance between the trunnion 1 and the liner to allow rotation of the trunnion 1. Accordingly, there is also a clearance between a packing sleeve of the trunnion 1 and the opening in the packing panel 2.

The packing panel 1 is part of a sealing system used to close off the clearance, so as to avoid the infiltration of the pulp/stock between the trunnion 1 and the liner, in the case of a vat. A stuffing box 3 is defined by the packing sleeve of trunnion 1, the packing panel 2, an annular wall 4 and a backing ring 5 (i.e., gland follower). Although only a portion of the stuffing box 3 is illustrated in FIG. 1, the stuffing box 3 defines an annular cavity about the packing sleeve of the trunnion 1. The stuffing box 3 incorporates wiper seals 6, which wiper seals 6 sealingly contact the packing sleeve of the trunnion 1, to prevent passage of liquids. However, the wiper seals 6 allow some infiltration of liquids in the stuffing box 3. As it may be abrasive or corrosive, the liquids may damage the surface of the packing sleeve of the trunnion 1.

As an alternative, the stuffing box 3 may accommodate packing that will block the passage of liquids between the packing sleeve of the trunnion 1 and the packing panel 2. In this case, the backing ring 5 is shaped to compress the packing into the stuffing box 3. As the efficiency of the packing decreases, the backing ring 5 is tightened so as to increase the pressure on the packing. However, the increased pressure has a wearing effect on the packing sleeve of the trunnion 1. Because of the packing, the sleeve of the trunnion 1 may wear out over time, resulting in expensive repairs.

### SUMMARY OF THE APPLICATION

It is an aim of the present application to provide a novel gasket for trunnions/shafts addressing issues associated with the prior art.

It is a further aim of the present application to provide a novel gasket and packing panel assembly for trunnions or shafts.

Therefore, in accordance with the present application, there is provided a gasket and packing panel assembly for use with a trunnion/shaft, the gasket and packing panel assembly comprising: a packing panel adapted to form a stuffing box about the trunnion/shaft, a backing ring about the trunnion/shaft and operatively connected to the packing panel so as to be movable in an axial direction relative to the trunnion/shaft to reduce an axial dimension of the stuffing box, and a gasket being located in the stuffing box, the gasket comprising a resilient body having at least one lip seal projecting therefrom, the lip seal projecting towards the trunnion/shaft, the at least one lip seal sealingly contacting the trunnion/shaft when the backing ring applies a pressure on the gasket.

Therefore, in accordance with the present application, there is also provided a gasket for use as a seal inside a stuffing box about a trunnion/shaft, the gasket comprising a resilient body, the resilient body having at least one lip seal projecting therefrom, the at least one lip seal having an inner radial surface facing towards the trunnion/shaft, and a contact surface corresponding to the inner radial surface of the at least one lip seal, the contact surface of the gasket having a surface area smaller than a total inner radial surface area of the gasket, the gasket sealingly contacting the trunnion/shaft with the contact surface when the gasket is compressed inside the stuffing box.

### BRIEF DESCRIPTION OF THE DRAWINGS

FIG. 1 is a perspective view of a trunnion and packing panel assembly for a reservoir in accordance with the prior art;

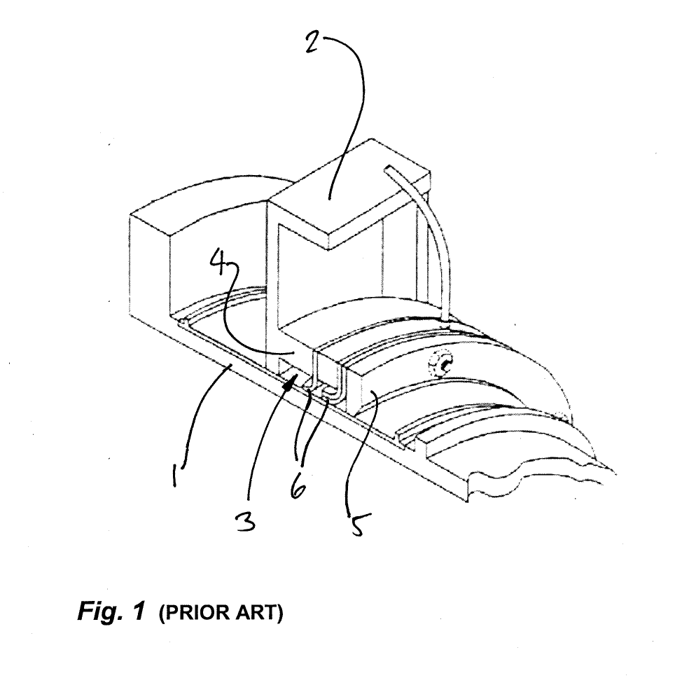

FIG. 2 is a schematic sectional view of a gasket accommodated in a stuffing box of the assembly of FIG. 1, in a non-compressed state;

FIG. 3 is a schematic sectional view of the gasket of FIG. 2, in a compressed state.

FIG. 4 is an enlarged schematic sectional view of a gasket similar to the gasket of FIG. 1, with a lip seal having a friction-resistant component located therein, according to another embodiment.

### DESCRIPTION OF THE EMBODIMENTS

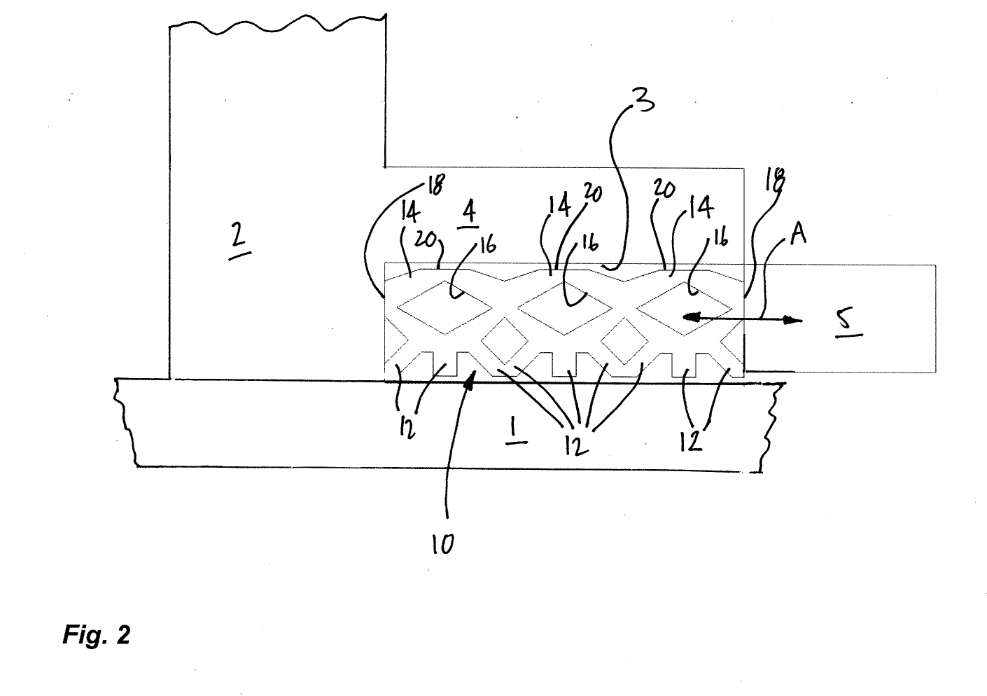

Referring to the drawings and more particularly to FIG. 2, a gasket in accordance with an embodiment of the present disclosure is generally shown at 10, as accommodated in the stuffing box 3 of a trunnion and packing panel assembly. The stuffing box 3 is defined by the trunnion/shaft 1 (through its packing sleeve), the packing panel 2, the annular wall 4 and the backing ring 5 (i.e., gland follower). It should be noted that in the embodiment shown in FIG. 2, the annular wall 4 forms an integral part of the packing panel 2. However, in another embodiment, the annular wall 4 may be a separate part, independent of the packing panel 2. The gasket 10 is designed to be used with any appropriate type of variable-size stuffing box 3, adjacent to a trunnion/shaft 1. The backing ring 5 (a.k.a., gland follower) may be any type of movable member which defines a portion of the stuffing box and encloses the gasket 10 therein.

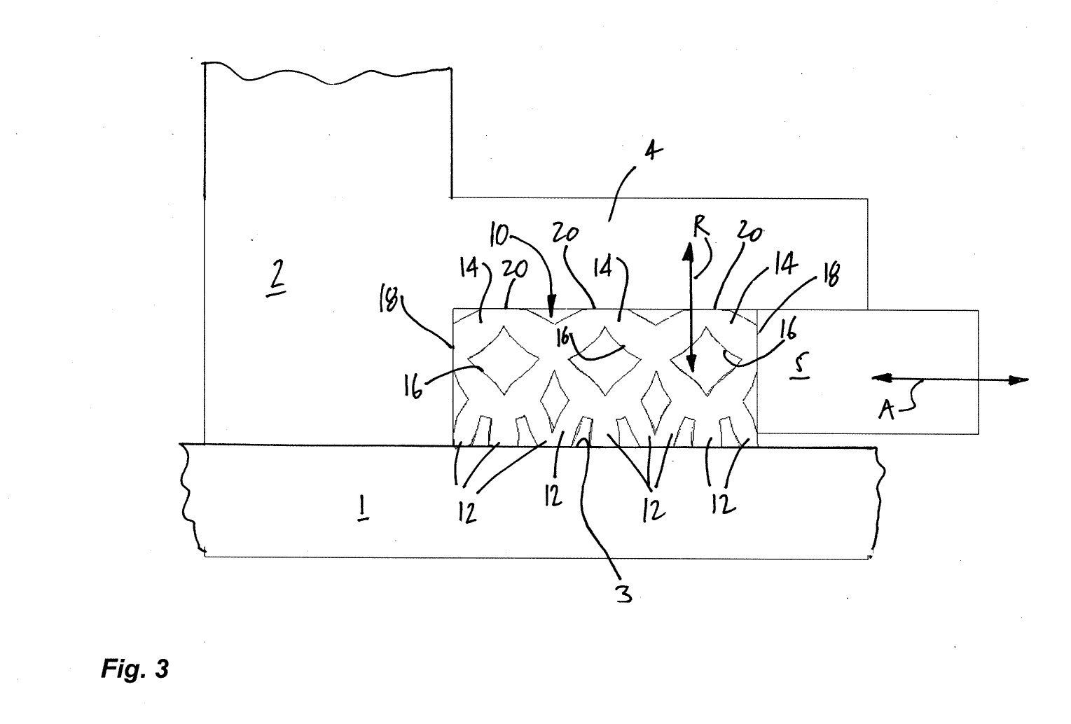

As shown in FIGS. 2 and 3, the backing ring 5 may move along direction A, namely into and out of the stuffing box 3, to modify the volume of the stuffing box 3. FIGS. 2 and 3 are sectional views, but it is pointed out that the stuffing box 3 has an annular shape extending about the periphery of the trunnion 1. For simplicity purposes, the backing ring 5 is illustrated as a rectangle in FIGS. 2 and 3, but is typically provided with fasteners such as bolts to allow its movement along direction A. As such, in one embodiment, the backing ring 5 may be operatively connected to the packing panel 2, or in another embodiment, to the annular wall 4, to allow relative movement therebetween. In this application, operatively connected is meant to signify that the backing ring 5 may move with respect to the packing panel 2 (or the annular wall 4, as per another embodiment), either by being attached directly thereon, or by being attached to a secondary structure. Moreover, even though the gasket 10 may be used with different types of shafts and trunnions, reference is made to the trunnion 1 below to simplify the description.

The gasket 10 comprises a resilient body having at least one lip seal 12 projecting therefrom. The gasket 10 illustrated in FIG. 2 comprises a resilient body having three similar segments each comprising three lip seals 12 projecting therefrom. In one embodiment, the resilient body may be a tubular member 14 circumscribing the trunnion/shaft. In the embodiment shown in FIG. 2, the three segments are tubular members 14, each tubular member 14 circumscribing the trunnion 1. Although three lip seals 12 project from each tubular member 14 in FIG. 2, it is considered to have one or more lip seal 12 on the tubular member 14. In one embodiment, the one or more lip seal 12 may be annular, but in another embodiment, the one or more lip seal 12 may not be annular, i.e. may have an arc length less than 2Π. When the gasket 10 is installed in the stuffing box 3, the lip seals 12 project downwardly so as to be facing toward the packing sleeve of the trunnion 1. It should be noted that the inner radial surfaces of the lip seals 12 comprise a surface area smaller than the total inner radial surface area of the gasket 10 as a whole, i.e., the inner radial surfaces of the lip seals 12 comprise an area smaller than the outer radial surface of the trunnion 1 which is opposed to the gasket 10. The seals 12, referred to as lip seals throughout, may be different types of seal that projects from a main body to form a limited surface of contact, such as a knife seal or the like. In one embodiment, the at least one lip seal 12 may be construed as a projection from the resilient body, the inner radial surface area of the at least one lip seal being less than the inner radial surface of the resilient body as a whole.

The tubular members 14 may each have an inner cavity 16. The inner cavities 16 may have various shapes, but have a diamond shape in FIG. 2. The tubular members 14 are connected to one another, thereby forming one integral seal having a width subsequently similar to that of the stuffing box 3. It is also observed that the adjacent lip seals 12 of adjacent tubular members 14 may be interconnected, as shown in FIG. 2. When adjacent lip seals are interconnected, inner cavities 22 may be formed therebetween.

The gasket 10 is typically an elongated strip curved into an annular shape when filling the stuffing box 3 in the manner shown in FIG. 2. The gasket 10 is made of a resilient sealing material, appropriately selected to sustain the exposure to the pulp/stock. More specifically, as the pulp vat may be used to separate the liquids from solids in different phases of the pulp (e.g., brown stock, bleached fiber, etc), different types and grades of materials may be used for the gasket 10. For instance, the gasket 10 may be of neoprene, or EPDM for brown stock. When the contents of the pulp include given levels of bleach, the gasket 10 may be made of AFLAS or Viton™. The gasket 10 may be extruded. Other materials are considered as well.

Referring to FIG. 3, the gasket 10 is illustrated as reacting to pressure from the backing ring 5. The pressure of the backing ring 5 causes an axial compression of the tubular members 14 (in the direction A), thereby causing a radial expansion (in the direction R). As a result of the radial expansion, the lip seals 12 are pressed against the packing sleeve of the trunnion 1, thereby forming a seal that prevents stock/pulp from passing. Moreover, the tubular member 14 contacts the other inner surfaces of the stuffing box 3, thereby stuffing the box and forming a seal therein. Considering the small surface of contact between the lip seals 12 and the trunnion 1, i.e. only the inner radial surface of the lip seals 12 is in contact with the trunnion 1 and not the inner radial surface of the gasket 10 as a whole, the friction on the sleeve of the trunnion 1 is minimal. In one embodiment, the tubular members 14 may be in contact with the walls of the stuffing box 3 prior to any compression or expansion of the gasket 10.

The expansion of the gasket 10 in the radial direction is increased by the hollowness of the tubular members 14, whereby it is preferred that the members 14 be hollow. However, the member 14 may be a non-hollow body, provided the material has a suitable resilience. In addition, the inner cavities 16 serve to increase the radial expansion of the gasket 10 when the gasket 10 is compressed axially, and thus minimally have an axial dimension. The inner cavities include axial points 17a, 17b and radial points 19a, 19b, at corners thereof, which act as joints, and wall portions 21, which act as linkages. More particularly, with respect to FIGS. 2 and 3, as the gasket 10 is compressed axially, the axial points 17a, of the inner cavities 16, will converge towards one another, whereas the radial points 19a, 19b of the inner cavities 16 will distance themselves away from one another, converting axial pressure on the gasket 10 to radial expansion thereof. Similarly, wall portions 21 may go from being largely axially oriented, as seen in FIG. 2, to being more radially oriented, as seen in FIG. 3. As such, the inner cavities 16 may also help in redirecting axial compression into radial expansion. The inner cavities 22 serve a similar purpose as that of inner cavities 16, namely inner cavities 22 allow an increase in radial expansion when the gasket 10 is axially compressed. In other words, the axial length of the cavities 16 and 22 decreases in size while the radial width of the cavities 16 and 22 increases in size when pressure is applied to the gasket by the stuffing box.

The opposed axial ends of the gasket 10 may have flat surfaces 18 to ensure a suitable contact between the gasket 10 and the axial walls of the stuffing box 3. The outer radial end of the gasket 10 may also have flat surfaces 20, to also ensure a suitable contact between the gasket 10 and the outer radial wall of the stuffing box 3.

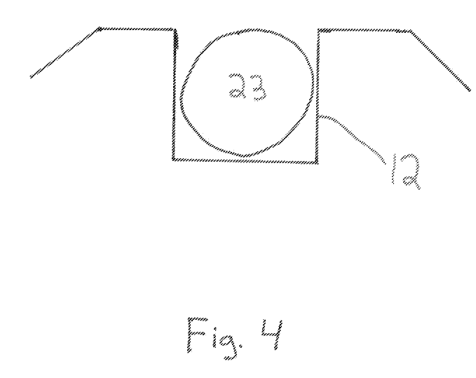

In one embodiment, as seen in FIG. 4, one of more of the lip seals 12 of the gasket 10 may comprise a friction-resistant component 23 located therein. As the trunnion 1 rotates, the material in which the lip seals 12 are made and which is in contact with the trunnion 1 may wear because of friction. The friction-resistant component may be used in order to resist longer to friction resulting from rotation of the trunnion 1. In one embodiment, the friction-resistant component 23 may be graphite, which has self-lubricating properties. As seen in FIG. 4, the friction-resistant component 23 may be located inside the lip seals 12. In the embodiment of FIG. 4, the friction-resistant component 23 may only become exposed and so in contact with the trunnion 1, once a certain amount of material has worn off from the bottom of the lip seal 12. In another embodiment, the low friction component 23 may be exposed and/or protrude from the lip seal 12, and as such, be in immediate contact with the trunnion 1.

If the gasket 10 loses its watertight effectiveness, the pressure on the gasket 10 may be increased by displacing the backing ring 5 into the stuffing box 3.

Although the gasket 10 is described and illustrated as having three interconnected segments, the gasket 10 may be an individual segment, with one or more individual segments accommodated in the stuffing box 3. If more than one segment is used, the segments are placed in side-by-side relation.

As the diameters of the trunnions 1 may be standard, it is considered to cut lengths of the gasket(s) to match the circumference of the trunnion 1, i.e., circumscribe. As an alternative, as the gasket 10 may be used with non-standard shafts and trunnions, it is considered to provide a length of gasket 10 to be cut in accordance with the circumference of the trunnion/shaft 1. A tool may be provided with the gasket 10 to cut the gasket 10 to the appropriate length. The installation and removal of the gasket into/from the stuffing box 3 is relatively straightforward. As the gasket 10 is made of a resilient material, the removal of the backing ring 5 results in the gasket 10 generally returning to its initial shape (FIG. 2), whereby the gasket 10 is readily removed from the opened stuffing box 3.

As opposed to packing that previously damaged the packing sleeve on the trunnion 1 because of a relative large contact area between the compressed packing and the trunnion, the contact surface between the gasket 10 and the trunnion 1 is reduced by having lip seals 12 interfaced with the trunnion 1. The wearing effect on the packing sleeve of the trunnion 1 may then be reduced.

Although the gasket 10 has generally been described as being used inside a stuffing box with a trunnion or shaft of a washer drum of a pulp vat, it should be understood that in other embodiments, the gasket 10 may be used in any stuffing box for use with a trunnion or shaft.

1. A gasket and packing panel assembly for use with a trunnion/shaft, the gasket and packing panel assembly comprising:
a packing panel adapted to form a stuffing box about the trunnion/shaft,
a backing ring about the trunnion/shaft and operatively connected to the packing panel so as to be movable in an axial direction relative to the trunnion/shaft to reduce an axial dimension of the stuffing box, and
a gasket being located in the stuffing box, the gasket comprising a resilient body having at least one lip seal projecting therefrom, the lip seal projecting towards the trunnion/shaft, the at least one lip seal sealingly contacting the trunnion/shaft when the backing ring applies a pressure on the gasket.

2. The gasket and packing panel assembly according to claim 1, wherein the resilient body comprises at least one tubular member circumscribing the trunnion/shaft.

3. The gasket and packing panel assembly according to claim 2, wherein the at least one tubular member has an inner cavity having a diamond-shaped cross-sectional area.

4. The gasket and packing panel assembly according to claim 1, further comprising a friction-resistant component incorporated inside the lip seal for contacting the trunnion/shaft.

5. The gasket and packing panel assembly according to claim 3, wherein the inner cavity has an axial length and a radial width, the axial length decreasing in size and the radial width increasing in size when the backing ring applies a pressure on the gasket.

6. The gasket and packing panel assembly according to claim 2, wherein the resilient body comprises multiple tubular members circumscribing the trunnion/shaft, each tubular member having at least one lip seal projecting therefrom, the tubular members being connected together to form one integral seal, each tubular member being removable from the remaining connected tubular members.

7. The gasket and packing panel assembly according to claim 6, wherein each tubular member comprises a plurality of lip seals, and wherein adjacent lip seals of adjacent tubular members are interconnected and inner cavities are defined between the adjacent lip seals and the tubular members.

8. The gasket and packing panel assembly according to claim 1, wherein the gasket comprises opposed axial ends and an outer radial end, the opposed axial ends and the outer radial end including flat surfaces to ensure a sealing contact with corresponding walls of the stuffing box.

9. The gasket and packing panel assembly according to claim 1, wherein the gasket and packing panel assembly is used on a trunnion/shaft of a washer drum of a pulp vat.

10. A gasket for use as a seal inside a stuffing box about a trunnion/shaft, the gasket comprising an elongated resilient body arranged to circumscribe the trunnion/shaft in the stuffing box, the resilient body having at least one lip seal projecting therefrom, the at least one lip seal having an inner radial surface contacting the trunnion/shaft, the inner radial surface of the gasket having a surface area smaller than an outer radial surface of the trunnion/shaft in the stuffing box, the at least one lip seal sealingly contacting the trunnion/shaft when the gasket is compressed inside the stuffing box.

11. The gasket according to claim 10, wherein the resilient body comprises at least one tubular member circumscribing the trunnion/shaft.

12. The gasket and packing panel assembly according to claim 11, wherein the at least one tubular member has an inner cavity with a diamond-shaped cross-sectional area.

13. The gasket according to claim 10, further comprising a friction-resistant component incorporated inside the lip seal for contacting the trunnion/shaft.

14. The gasket according to claim 11, wherein the resilient body comprises multiple tubular members circumscribing the trunnion/shaft, each trunnion/shaft having at least one lip seal projecting therefrom, the tubular members being connected together to form one integral seal, each tubular member being removable from the remaining connected tubular members.

15. The gasket according to claim 10, wherein the gasket comprises opposed axial ends and an outer radial end, the opposed axial ends and the outer radial end including flat surfaces to ensure a sealing contact with corresponding walls of the stuffing box.

16. The gasket according to claim 14, wherein each tubular member comprises a plurality of lip seals, and wherein adjacent lip seals of adjacent tubular members are interconnected and inner cavities are defined between the adjacent lip seals and the tubular members.

17. The gasket and packing panel assembly according to claim 12, wherein the inner cavity has an axial length and a radial width, the axial length decreasing in size and the radial width increasing in size when the backing ring applies a pressure on the gasket.

18. The gasket according to claim 17, wherein the gasket is used on a trunnion/shaft of a washer drum of a pulp vat.
